(19) United States
(12) Patent Application Publication
(10) Pub. No.: US 2014/0201059 A1
(43) Pub. Date: Jul. 17, 2014

(54) PREPAID MULTINATIONAL PROGRAM

(71) Applicant: Michael Chittaro, San Francisco, CA (US)

(72) Inventor: Michael Chittaro, San Francisco, CA (US)

(21) Appl. No.: 14/156,259

(22) Filed: Jan. 15, 2014

Related U.S. Application Data
(60) Provisional application No. 61/752,890, filed on Jan. 15, 2013.

(51) Int. Cl. G06Q 20/28; G06Q 20/10

(52) U.S. Cl. CPC G06Q 20/28; G06Q 20/10; G06Q 40/04
USPC 705/37; 705/39

(57) ABSTRACT

A system and method for providing multinational prepaid services in a plurality of countries is provided. A multinational organization can work with an originating issuer to implement a corporate disbursement program in a number of countries. The multinational organization can provide a device file to a multinational prepaid system. The multinational prepaid system can split the device file into a plurality of destination device files for a plurality of destination issuers in each country where the funds need to be disbursed. The multinational prepaid system can provide a funding file to a funds transfer system to convert the funds from an originating country currency into a destination country currency for each country and to deliver the funds to the appropriate destination issuer in each country. The destination issuers can then distribute prepaid funds in their respective local currency to the specified recipients based on the destination device file.

### CROSS-REFERENCES TO RELATED APPLICATIONS

This application is a non-provisional application of and claims priority to U.S. Provisional Application No. 61/752,890 titled “Prepaid multinational program,” filed Jan. 15, 2013, which is herein incorporated by reference in its entirety for all purposes.

### BACKGROUND

Corporate and government organizations transfer funds around the world for disbursement programs such as multinational employee incentives, channel and agent incentives, payroll, insurance, government expat payments, etc. Recently there has been a shift from checks or cash to prepaid cards for payouts by multinational organizations.

In most cases, a multinational organization contacts a local bank to issue a number of prepaid cards. However, relationships between banks throughout the world are not well defined and transfers of funds between a bank associated with the multinational organization and bank around the world can be costly, time intensive, and inefficient as wire transfers may require multiple transfers between middlemen, currency exchanges, and a large administrative structure to provide oversight and enforcement programs. Additionally, local banks are typically restricted from sending prepaid cards directly to foreign countries due to central banking rules specific to those countries. Furthermore, issuing prepaid cards in U.S. dollars to foreign countries has proven costly and resource intensive for the issuing banks, multinational organizations, and the fund recipients. Finally, in many countries, central banking rules prohibit prepaid cards from being imported, thus, making the disbursement program difficult to implement.

Embodiments of the invention address these and other problems, individually and collectively.

### BRIEF SUMMARY

Embodiments of the invention are directed at systems and methods for providing multinational prepaid services in a plurality of countries for a multinational organization using a multinational prepaid system. For example, a multinational organization may sign an agreement with an originating issuer to implement a corporate disbursement program in a number of countries. The multinational organization may provide a device file with recipient information to the originating issuer. For example, the device file may include a card file including a plurality of fund recipient information. The originating issuer may provide the card file to the multinational prepaid system. The multinational prepaid system may split the card file into a plurality of destination card files associated with a plurality of destination issuers in different countries. The plurality of destination card files may correspond to a plurality of currencies and/or countries. The multinational prepaid system may provide a funding file to a funds transfer system which may be configured to transfer funds from the originating issuer to the plurality of destination issuers. The funds transfer system may use the prepaid funding file to initiate a plurality of fund transfers, wherein each of the fund transfers is associated with one of the plurality of destination issuers. The plurality of destination issuer can then issue prepaid cards in their respective destination country currency. In some embodiments, a trading platform associated with a payment processing network may be used for trading and settlement of the funds from the originating country currency into a plurality of destination country currencies. The payment processing network may also be associated with the multinational prepaid system and the funds transfer system.

One embodiment of the invention relates to a method of processing multinational prepaid funding transactions. The method comprises receiving a device file including recipient information for a plurality of fund recipients from an originating issuer in an originating country. The method further comprises splitting the device file into a plurality of destination device files, wherein each of the destination device files includes one or more of the plurality of fund recipients. The method further comprises generating a prepaid funding file including exchange information for each of the plurality of destination device files and providing the plurality of destination device files to a plurality of destination issuers. The method further comprises transferring a plurality of funds to the plurality of destination issuers from the originating issuer using the prepaid funding file, wherein the plurality of destination issuers provide a portion of the transferred funds to each of the plurality of fund recipients associated with the received destination device file of the plurality of destination device files as prepaid funds.

Another embodiment of the invention is directed to a server computer comprising a processor, and a computer readable medium coupled to the processor, the computer readable medium comprising code, executable by the processor for implementing a method of processing multinational prepaid funding transactions. The method comprises receiving a device file from an originating issuer in an originating country, wherein the device file comprises recipient information for a plurality of fund recipients. The method further comprises splitting the device file into a plurality of destination device files, wherein each of the destination device files include one or more of the plurality of fund recipients. The method further comprises generating a prepaid funding file including exchange information for each of the plurality of destination device files and providing the plurality of destination device files to a plurality of destination issuers. The method further comprises transferring a plurality of funds to the plurality of destination issuers from the originating issuer using the prepaid funding file. The plurality of destination issuers can provide a portion of the transferred funds to each of the plurality of fund recipients associated with the received destination device file of the plurality of destination device files as prepaid funds.

Another embodiment of the invention is directed to a system for processing multinational prepaid funding transactions. The system comprises an originating issuer computer located in an originating country and a plurality of destination server computers, wherein the originating issuer computer is configured to submit a device file comprising information for a plurality of fund recipients to an exchange server computer. The exchange server computer is configured to receive the device file from the originating issuer computer and split the device file into a plurality of destination device files, wherein each of the destination device files includes information for one or more of the plurality of fund recipients. The exchange server computer is further configured to provide the plurality of destination device files to a plurality of destination issuer computers associated with a plurality of destination issuers and transfer a plurality of funds to the plurality of destination issuers from the originating issuer. The plurality of destination issuer computers are configured to provide a portion of the transferred funds to each of the plurality of fund recipients associated with the received destination device file as prepaid funds.

### BRIEF DESCRIPTION OF THE DRAWINGS

FIG. 1 illustrates an exemplary system with at least some of the elements for providing multinational prepaid services in accordance with some embodiments of the invention.

FIG. 2 illustrates a funds transfer flow in accordance with an embodiment of the invention.

FIG. 3 illustrates some components of a server computer associated with a multinational prepaid system in one embodiment of the invention.

FIG. 4 illustrates some components of a server computer associated with a funds transfer system in one embodiment of the invention.

FIG. 5 illustrates an exemplary flow chart illustrating a method for implementing some embodiments of the invention.

FIG. 6 illustrates a screen shot displaying a user interface to submit a new request for information, in one embodiment of the invention.

FIG. 7 illustrates a screen shot displaying a user interface for submitting an RFI response by a destination issuer, in one embodiment of the invention.

FIG. 8 illustrates a screen shot displaying a user interface for submitting an RFI reply by an originating issuer, in one embodiment of the invention.

FIG. 9 illustrates a screen shot displaying a user interface for creating an issuance program by an originating issuer, in one embodiment of the invention.

FIG. 10 illustrates a screen shot illustrating an originating issuer user interface for an issuance program, in one embodiment of the invention.

FIG. 11 illustrates a screen shot illustrating issuer program details on the destination issuer (DI) dashboard, in one embodiment of the invention.

FIG. 12 illustrates a screen shot illustrating a destination issuer user interface for submitting invoice details, in one embodiment of the invention.

FIG. 13 illustrates a screen shot illustrating invoice details on an originating issuer's dashboard, in one embodiment of the invention.

FIG. 14 illustrates a screen shot illustrating a high level user interface for the multinational prepaid system, in one embodiment of the invention.

FIG. 15 shows an exemplary computer apparatus in accordance with some embodiments.

### DETAILED DESCRIPTION

Current solutions for implementing corporate disbursement programs in different countries require a multinational organization to work with a local bank (e.g., a U.S. based bank) to issue prepaid cards that may be distributed by the organization to various recipients (e.g., employees, customers, clients, etc.) in different countries. Such solutions are expensive and resource intensive for the local bank as well as for the organization. Additionally, central banking rules in some countries may not allow importing cards in foreign currencies, thus making the multinational corporate disbursement program difficult to implement.

Embodiments of the invention provide an efficient solution for multinational prepaid systems (MPS) by transferring the fund recipient information and the funds from an originating issuer in an originating country to a plurality of destination issuers in various destination countries. The destination issuer in each destination country can then issue prepaid cards to the specified fund recipients in their respective destination currency. Such multinational prepaid systems provide a matrix of issuers for more efficient prepaid card transfers by connecting the originating issuer (e.g., a local bank associated with a multinational corporation) with many destination issuers (e.g., foreign banks) and vice-versa. Accordingly, the multinational prepaid system eliminates the need for the issuers to manage the contracting, funding, foreign exchange (f/x), and vendor management of multi-national programs. An issuer may be a bank or a financial institution capable of handling financial transactions.

A multinational client (e.g., organization, corporation, etc.) may want to implement an corporate disbursement program (e.g., incentives, payroll, pension, commissions, dividend payments, rewards, etc.) in a number of countries. In some embodiments of the invention, the multinational client can work with a program manager that may be associated with an originating issuer (e.g., an employee of the originating issuer) or a third party agent (e.g., benefit providers) to provide funds to a plurality of fund recipients in various destination countries. The originating issuer and a plurality of destination issuers associated with different countries may register with the multinational prepaid system in order to participate in the prepaid program. The multinational prepaid system may allow the registered originating issuers and the destination issuers to exchange information using one or more web applications associated with the multinational prepaid system. In some embodiments, the multinational prepaid system may be associated with or provided by a payment processing network (e.g., Visa®) which have pre-existing relationships with many issuers around the world and the infrastructure for providing multi-national payment and settlement.

The program managers (e.g., third party organizations or managers at an originating issuer) associated with the originating issuer may submit requests for information (e.g., bids) from a plurality of destination issuers associated with various destination countries to initiate a prepaid program. The originating issuers and the destinations issuers may communicate via one or more applications associated with the multinational prepaid system to exchange information regarding the pricing for issuance of cards, timeline for card distribution, and any other related information. Once negotiations have been completed, a decision can be made regarding one or more destination issuers in each destination country that can facilitate or issue the prepaid funds based on the agreed upon program terms between the originating issuer and the destination issuers.

Before, during, or after negotiations and agreements have been made regarding the terms of a multi-national prepaid program, the multinational client (e.g., organization) may provide a card file including recipient information to one or more program managers that may be associated with the originating issuer or a third party agent. The one or more program managers associated with the originating issuer may provide the card file to the multinational prepaid system. The multinational prepaid system may parse the card file into a plurality of destination card files for each destination issuer associated with a destination country and/or currency. The multinational prepaid system may parse the card file by currency, country, region, economic zone, or through any other suitable designation.

The originating issuer may create an issuance program and can be the primary approver for that program. In some embodiments, the issuance program may be submitted for approval by a secondary approver that may be associated with a third party financial organization or the originating multinational organization. Once the approvals are in place, the program may be submitted for funding.

The multinational prepaid system may generate a prepaid funding file that can include exchange information for each of the destination card files. For example, the exchange information may include foreign exchange rates for each of a plurality of currencies associated with a plurality of destination issuers, a plurality of values in an originating currency, where each value is associated with each of the destination card files, and account information associated with the originating issuer and the plurality of destination issuers. Any other information (e.g., broker or trader information, time of execution, etc.) that may be relevant to initiating one or more funds transfers and/or foreign exchange transactions may be included in the exchange information. Additionally, each destination card file may be provided to each of the respective destination issuers in each destination country (or currency where applicable).

In one embodiment, a funds transfer system can transfer funds using a trading platform associated with a payment processing network (e.g., Visa® or VisaNet®) from an account associated with the originating issuer to one or more accounts associated with each destination issuer based on information in the prepaid funding file. The use of a typical trading platform may provide non-obvious advantages including more efficient settlement processing due to aggregation of funding requests (in order to obtain the best possible exchange rates, lowest trading costs, and provide more efficient use of system resources) and periodic disbursement of funds. The funds transfer system may be an independent entity or it may be part of the multinational prepaid system. The trading system may initiate wire transfers and funding transactions between the originating issuer, currency exchanges, and the various destination issuers in order to provide the designated funds to each destination issuer in their local currency. The destination issuer in each destination country can then issue the prepaid funds in the local currency to specified recipients based on the received destination card files.

After the funds are issued, the plurality of destination issuers may provide a plurality of invoices associated with issuance of the prepaid funds to the multinational prepaid system. The multinational prepaid system may manage and facilitate the invoicing process by generating an invoice funding file including exchange information for each of the plurality of destination card files and may use the funds transfer system in order to provide payment for the agreed upon costs associated with facilitating the prepaid program (e.g., the destination issuer costs of producing, distributing, and managing the prepaid program for the originating issuer). The exchange information included in the invoice funding file may include foreign exchange rates for each of the plurality of currencies associated with each destination issuer and account information associated with the originating issuer and the destination issuers for transfer of funds. Accordingly, a plurality of invoice funds may be transferred to the plurality of destination issuers from the originating issuer using the same trading platform used for transferring the prepaid funds.

Embodiments provide a number of advantages including providing efficient, timely, and cost effective international money transfer for multinational organizations with recipients located throughout the world. The system allows a multinational organization to generate a single recipient information card file that includes all of the disbursement information associated with each recipient, splits the single card file into multiple destination card files associated with destination issuers in each country, currency, (or other division), and provides funds to each destination issuer in the fewest possible number of transactions. Accordingly, embodiments provide for more efficient use of system resources by limiting the number of transaction necessary to connect parties throughout the world and allows for more cost-effective, efficient, and competitive fund transfers to destination issuers located throughout the world.

Furthermore, the fewest number of transactions between financial entities allows for lower cost international money transfers as fewer middlemen financial organizations are involved in the money transfer. Additionally, administrative and management costs are minimized by directly connecting an originating issuer with the various destination issuers that are able to directly provide funds to the recipients. Finally, the multinational prepaid system provides foreign exchange of the funds before transferring to a destination issuer to ensure that the multinational organization and the recipients receive the best possible foreign exchange rates. Accordingly, recipients are not charged higher exchange rates every time they use the prepaid funds in the destination country. Accordingly, embodiments of the present invention provide a number of technical advantages by providing a single integration point for multinational organizations and a central aggregation point for distributing funds throughout the world to numerous destination issuers in multiple countries, regions, and areas throughout the world.

The specific description below discusses the use of card files and the issuance of prepaid cards. However, embodiments of the invention are not limited thereto. Embodiments of the invention may include other payment device form factors including contactless fobs, mobile communication devices such as mobile phones, etc.

Prior to discussing embodiments of the invention, a description of some terms may be helpful in understanding embodiments of the invention.

An “originating issuer” (OI) may include any financial institution such as, for example, a bank that initiates a funding program. The originating issuer may manage an account or have an association with a multinational corporation, organization, client, or entity such that the originating issuer may provide funds on the multinational clients behalf. In some embodiments, one or more program managers may also be associated with the originating issuer. The program manager may be an employee of the originating issuer or may be a third party agent or other entity that is associated with the multinational organization. The multinational organization may desire to distribute prepaid cards to recipients globally. The multinational organization may provide funds to the originating issuer in an originating country currency for disbursement to employees located in different countries throughout the world with different foreign currencies. For example, a multinational organization (e.g., Corporation A) may provide $100,000 U.S. Dollars (USD) to a U.S. based bank (an originating issuer) to distribute $1,000 to 20 different recipients (e.g., employees) in each of five different countries in the currency of each country where the employees reside (e.g., in five different currencies). In embodiments of the invention, a Bank Identification Number (BIN) or other bank identifier (e.g., registered bank identifier) may be associated with the originating issuer that may be used to identify the issuer. In some embodiments of the invention, the originating issuer may be capable of initiating an issuance program and funding requests for a multinational prepaid program.

An “originating country” may refer to a country where the prepaid program originates. For example, a multinational organization may provide funds to a bank (originating issuer) based in the U.S. (originating country) to initiate a prepaid program for distribution of funds in different foreign countries. However, it will be understood that the prepaid program may be initiated in any country.

A “destination country” may refer to a country where the funds may be distributed. A plurality of destination countries may include two or more destination countries. In some embodiments of the invention, funds may be distributed in a first destination country (e.g., Singapore) in a first currency (e.g., Singapore Dollars) and in a second destination country (e.g., Japan) in a second currency (e.g., Japanese Yen). In some embodiments, funds may be distributed in more than one currency in the same destination country and in some embodiments, funds may be issued in the same currency for multiple countries.

A “destination issuer” (DI) may include a financial institution (e.g., a bank) that receives funds under a funding program. In some embodiments of the invention, a destination issuer may be capable of issuing prepaid funds to various recipients in their respective destination country currency based on recipient information received in a destination card file. For example, a destination issuer may be a bank in Singapore which can issue prepaid cards in Singapore Dollars to employees of a Singapore branch of a multinational organization. A destination issuer may also be able to provide pricing in response to requests for information from the originating issuers and also generate invoices for the issuance of prepaid funds services. In some embodiments, one or more program managers may be associated with each destination issuer similar to the program managers associated with a originating issuer. Further, in some embodiments, a destination issuer may be configured to provide prepaid funds to a number of different recipients located in other countries that share the same currency and/or financial regulations. For example, it may be possible for a destination issuer located in France to issue prepaid funds to recipients located in Spain in Euros.

“Fund recipients” may include one or more entities (e.g., organizations, employees, persons, citizens, etc.) that can receive funds in a local currency. In some embodiments, the funds may be received as prepaid cards issued in the currency of the destination country. For example, fund recipients in Singapore may receive the funds in Singapore Dollars, whereas, fund recipients in Japan may receive the funds in Japanese Yen. The fund recipients may be individuals that may be employees, clients, or customers of the multinational organization. In some embodiments, the clients or customers may be associated with a company.

A “device file” may include any message, data structure, or information associated with issuance of a plurality of funds to a plurality of fund recipients. A device file may include a card file. For example, a card file may include recipient information associated with issuance of 50 prepaid cards to 50 employees of a multinational client in Brazil, 200 prepaid cards to 200 employees in China and 100 prepaid cards to 100 employees in Hong Kong for an rewards program. Some non-limiting examples of a record in the card file may include a multinational client identifier, a program identifier, contact information of the fund recipients (e.g., name, shipping address, phone number, email address, etc.), fund recipient identification numbers, prepaid values for each recipient, expiration dates, device activation codes, etc.

A “plurality of destination device files” may include two or more device files associated with two or more destination issuers. For example, a plurality of destination device files may include a plurality of destination card files. In some embodiments, each destination card file in the plurality of destination card files may include information associated with issuance of funds to one or more of the plurality of fund recipients associated with a destination issuer in a destination country. Referring back to the previous example, a first destination card file may include information associated with issuance of 50 cards to 50 fund recipients in Brazil, a second destination card file may include information associated with issuance of 200 cards to 200 fund recipients in China and a third destination card file may include information associated with issuance of 100 cards to 100 fund recipients in Hong Kong. Accordingly, a single card file may be split into a plurality of destination card files associated with different countries, currencies, regions, etc., associated with the fund recipients included in the card file.

“Splitting” may refer to parsing one card file into two or more card files. For example, splitting a card file into a plurality of destination card files may include aggregating the information associated with fund recipients in a first destination country and parsing it into a first destination card file, aggregating the information associated with fund recipients in a second destination country and parsing it into a second destination card file, and so on for each of the destination country. In some embodiments, aggregating the information may be based on the region, countries, and/or currencies associated with a destination issuer or may be based on the region, country, or currency associated with fund recipients of the card file.

“Foreign exchange rates” may include a conversion rate of a local currency into a foreign currency (and vice versa). For example, a foreign exchange rate of one U.S. dollar (representing a local currency) for one Japanese Yen (representing a foreign currency) is about 104 in the first week of year 2013.

A “funding file” may include information associated with transfer of funds from an originating issuer to a plurality of destination issuers. For example, the transfer of funds may be associated with issuance of prepaid funds to fund recipients or for invoices for the costs of providing prepaid services to a destination issuer. In some embodiments, the funding file may include a plurality of records associated with a plurality of destination issuers. Each record of the plurality of records may include a plurality of fields. For example, the plurality of fields may include, but are not limited to, a file type (e.g., an issuance or invoice file type), a time stamp to indicate a date and time that the file was created, an effective rate period for exchange rates, a transaction identifier, a settlement system identifier, an originating currency code to indicate the originating issuer currency, a destination currency code to indicate the destination issuer currency, an originating currency amount to indicate the originating issuer currency amount, a destination currency amount to indicate the destination issuer currency amount, and a record count. In some embodiments, the funding file may include a pair of records associated with each transaction identifier that can be differentiated as a sell record or a buy record using a direction identifier field to indicate whether the funding file is associated with a transferor or a transferee. For example, a first record in the pair may include a sell currency code, an originating issuer total currency amount, and a sell direction indication. A second record in the pair may include a buy currency code, a destination issuer currency amount, and a buy currency code. Both the first and second records may include the same transaction identifier.

“Exchange information” may include any information associated with transfer of funds from a first (e.g., an originating country) currency to a second (e.g., a destination country) currency. The exchange information may be associated with the prepaid funding file or the invoice funding file. In some embodiments, the exchange information may include foreign exchange rates for a plurality of currencies, a plurality of values in an originating country currency for converting to a plurality of destination country currencies and account information associated with the originating issuer and the plurality of destination issuers.

“Funds” may refer to a sum of money. For example, funds may represent an amount of money that may be traded from a first currency into a second currency based on an exchange rate. Funds may also represent an amount of money that is transferred from an originating account into one or more trading accounts (for currency exchange) and subsequently to one or more destination accounts. Funds may be provided to a recipient in a number of ways such as, for example, via a prepaid card in a local currency or via deposit into a bank account, etc.

A “server computer” may typically be a powerful computer or cluster of computers. For example, the server computer can be a large mainframe, a minicomputer cluster, or a group of servers functioning as a unit. In one example, the server computer may be a database server coupled to a web server.

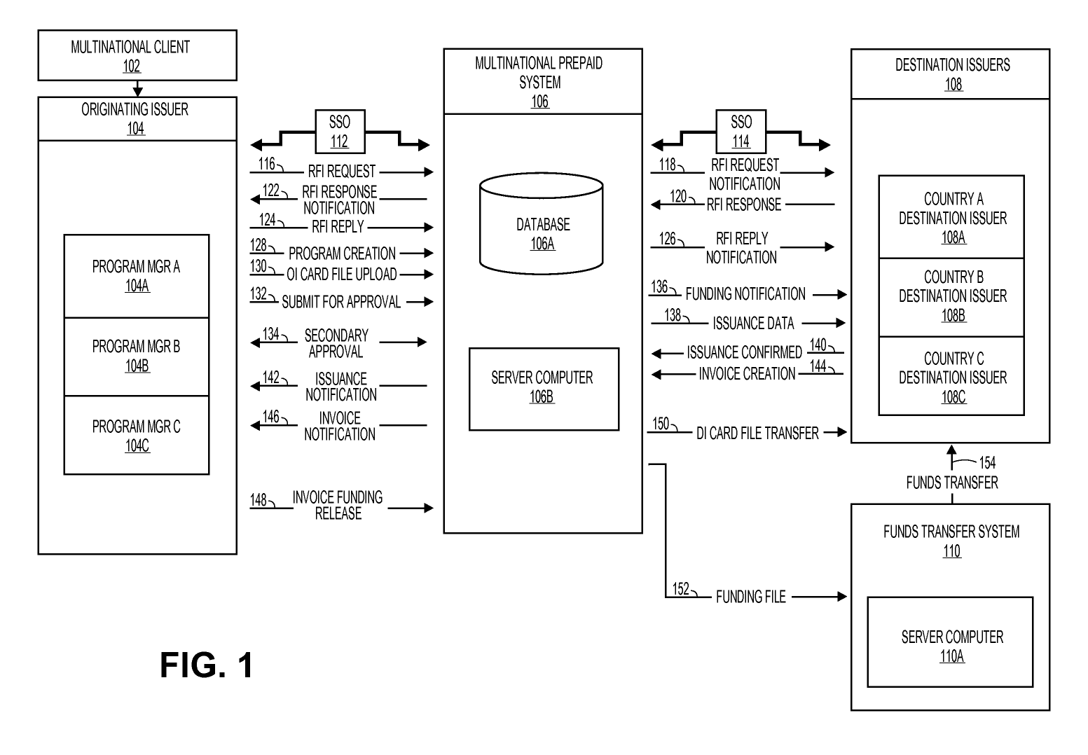

FIG. 1 illustrates a system 100 with at least some of the components for providing multinational prepaid fund transfers in accordance with some embodiments of the invention. The system 100 may include a multinational client 102, an originating issuer 104, a multinational prepaid system 106, destination issuers 108, and a funds transfer system 110. In some embodiments, the multinational prepaid system 106 and the funds transfer system 110 may be associated with a payment processing network such as VisaNet®. Further, although the funds transfer system 110 is shown as separate from the multinational prepaid system 106 in FIG. 1, in some embodiments the funds transfer system 110 may be incorporated into the multinational prepaid system 106.

The multinational client 102 may be an organization with a presence in more than one country or region. For example, the multinational client 102 may have employees, clients or customers in a plurality of countries. The multinational client 102 may desire to distribute a number of prepaid cards to specific recipients in certain countries, for example, countries A, B, C. For example, distribution of the prepaid cards may be part of a corporate disbursement program involving payouts to employees, clients, or customers for payroll, pension, commissions, dividend payments, rewards or any such program.

The originating issuer 104 may be a financial institution that can represent the multinational client 102 for implementation of the multinational prepaid program. For example, the originating issuer 104 may manage an account of the multinational client 102 or may receive funds on behalf of the multinational client 102. In one embodiment, one or more program managers such as program manager 104A, program manager 104B and/or program manager 104C may be associated with the originating issuer 104 for managing the multinational prepaid program on behalf of the multinational client 102. In another embodiment, the program managers 104A, 104B, 104C may be associated with a third party (e.g., a prepaid card service, benefits provider, etc.) that is associated with the originating issuer 104.

An opt-in participation agreement may be signed by the originating issuer 104 and the destination issuers 108 to enroll in the multinational prepaid service. The participating agreement may include operating guidelines and/or regulations which may vary for each country, and may be followed by each participating issuer.

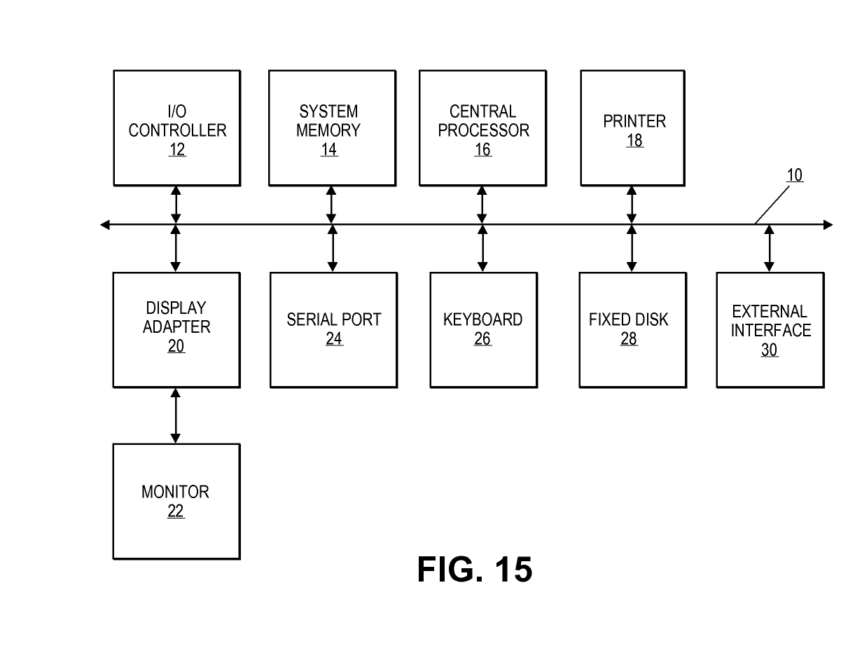

The originating issuer 104 may be configured to initiate and submit one or more requests for information (RFI), card issuance programs and funding requests to the destination issuers 108 via the multinational prepaid system 106. The originating issuer 104 may also be configured to respond to the invoices submitted by the destination issuers 108 for their card distribution services. The originating issuer may be associated with an originating issuer computer (not shown) that may include at least some of the components as described with reference to FIG. 15.

The multinational prepaid system 106 may include a database 106A and a server computer 106B. The database 106A may be communicatively coupled to the server computer 106B either externally or internally within the multinational prepaid system 106. For example, the database 106A may be hosted on a remote server (e.g., a “cloud” server) or may be provided within the multinational prepaid system (as shown in FIG. 1).

The multinational prepaid system 106 may be configured to connect the originating issuers representing various multinational organizations with destination issuers around the world and provide them with an end-to-end connection for sourcing, creating, managing, funding, and issuing prepaid cards. In one embodiment, the multinational prepaid system 106 may provide a secure environment including one or more applications that may be accessed by the originating issuer 104 and the destination issuers 108 using a graphical user interface to exchange information and funds associated with sourcing, creating, managing, funding, and issuing the prepaid cards.

The server computer 106B may be configured to receive a card file including information associated with a plurality of fund recipients from the originating issuer 104 in an originating country. In one embodiment, the card file information may be stored in the database 106A. The server computer 106B may also be configured to split the card file into a plurality of destination card files wherein each of the destination card files includes information for one or more of the plurality of fund recipients. The server computer 106B may further be configured to provide the plurality of destination card files to the destination issuers 108. The server computer 106B may further be configured to generate a prepaid funding file including exchange information for each of the plurality of destination card files. The exchange information may include foreign exchange rates for each of a plurality of currencies, a plurality of values in an originating currency, each value of the plurality of values being associated with or corresponding to each of the destination card files, and account information associated with the originating issuer 104 and the destination issuers 108. In some embodiments, the funding file may include information associated with a trading account or currency exchange that may be used to exchange money from one currency into another currency to facilitate the fund transfers between the originating issuer 104 and the destination issuers 180A-108C.

The destination issuers 108 may include a plurality of destination issuers associated with a plurality of countries. For example, the destination issuers 108 may include a country A destination issuer 108A, a country B destination issuer 108B, and a country C destination issuer 108C. Note that for illustrative purposes, three destination issuers in three countries are shown in FIG. 1, however, any number of destination issuers and countries are possible. For example, one country may have multiple issuers and, as another example, one issuer may be located in multiple countries. Each of the destination issuers 108A, 108B, and 108C may be a financial institution such as a bank that may be configured to issue prepaid funds (e.g., prepaid cards) in the currency of their respective country. For example, the destination issuer 108A may issue prepaid funds in a currency A associated with country A, the destination issuer 108B may issue prepaid funds in a currency B associated with country B and so on.

The destination issuers 108 may be configured to respond to the RFI requests and provide costs, quotes, bids, offers, counter-offers, and any other information regarding the card issuance programs to the originating issuer 104 via the multinational prepaid system 106. The destination issuers 108 may also be configured to initiate and submit the invoices for their card distribution services. In one embodiment, each of the destination issuers 108A, 108B, and 108C may also include a program manager (e.g., an employee of the destination issuer or a third party agent) that may be used to issue funds to recipients, manage all program management activities including, for example, customer service, and report various card activities back to the multinational prepaid system 106. Each of the destination issuers 108A, 108B, and 108C may be associated with a destination issuer computer that may include at least some of the components as described with reference to FIG. 15.

In some embodiments of the invention, a financial institution may operate as both an originating issuer and as a destination issuer and a program manager or other third party agent can manage both types of programs for a financial institution. For example, an employee at an originating issuer may manage both prepaid program creation on behalf of the originating issuer and card issuing for a different prepaid card program where the issuer is acting as a destination issuer. Alternatively, a third party agent may manage both originating and destination issuer programs on behalf of a financial institution.

The originating issuer 104 may be configured to access the multinational prepaid system 106 using a secure authenticated connection, for example, using a SSO (Single Sign-On/Single Sign-Off) 112 process. In one embodiment, the SSO 112 may enable the originating issuer 104 to access multiple distinct applications associated with the multinational prepaid system 106 using a single authentication process (e.g., by providing a user id and a password once). Similarly, the destination issuers 108 (or a program manager acting on behalf of a destination issuer) may be configured to access the multinational prepaid system 106 using a SSO 114 process. In one embodiment, the SSO 114 may enable each of the destination issuers 108 to access multiple distinct applications associated with the multinational prepaid system 106 using a single authentication process (e.g., by providing their respective username and password once). In some embodiments, the authentication process may involve verifying a user's role, a list of authorized BINs associated with the user, and the financial institution associated with the user. The user may be a program manager (e.g., employee of the financial institution or a third party agent) associated with the originating issuer 104, any of the destination issuers 108, or an administrator associated with the multinational prepaid system 106.

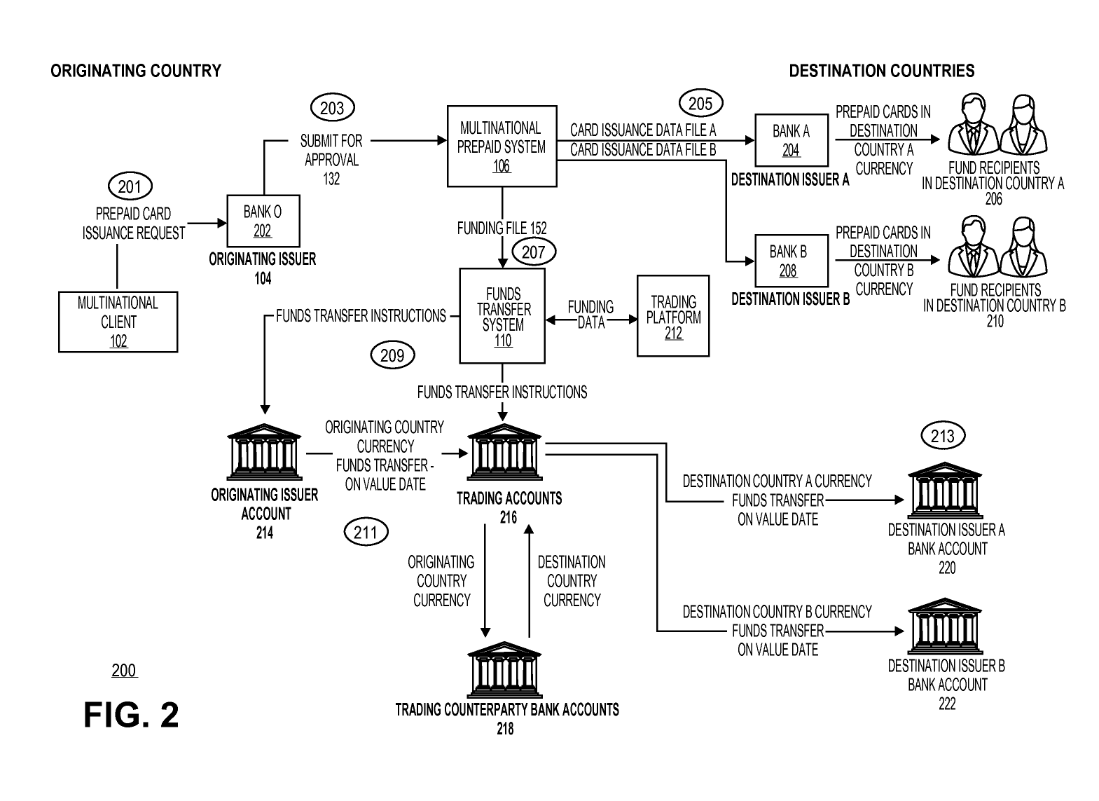

The funds transfer system 110 may include a server computer 110A. The server computer 110A may be configured to receive a funding file from the multinational prepaid system 106, initiate trading of funds from an originating currency into specified foreign currencies, and transfer funds in foreign currencies to the respective destination issuers 108A, 108B and 108C. Operation of the funds transfer system 110 is explained in further detail below in reference to FIG. 2.

In some embodiments, exchange rates used for the conversion of originating country currency into a plurality of destination country currencies may be based on a foreign exchange rate file. The foreign exchange rate file may be provided by the funds transfer system 110 or by an external organization or system (not shown). For example, the foreign exchange rate file may be uploaded to the multinational prepaid system 106 using a SFTP protocol (Secure File Transfer Protocol) over a communication network such as, for example, the Internet. The foreign exchange rate file may include but is not limited to a timestamp, an effective date when the rates can be applied, an end date for expiration of the rates, an originating country currency code, one or more destination country currency codes, an exchange rate for each destination country currency, and a record count for the number of currencies.

A process for completing a prepaid funding program using the multinational prepaid program is described below with reference to FIG. 1 using exchange of communications messages among different components of the system 100.

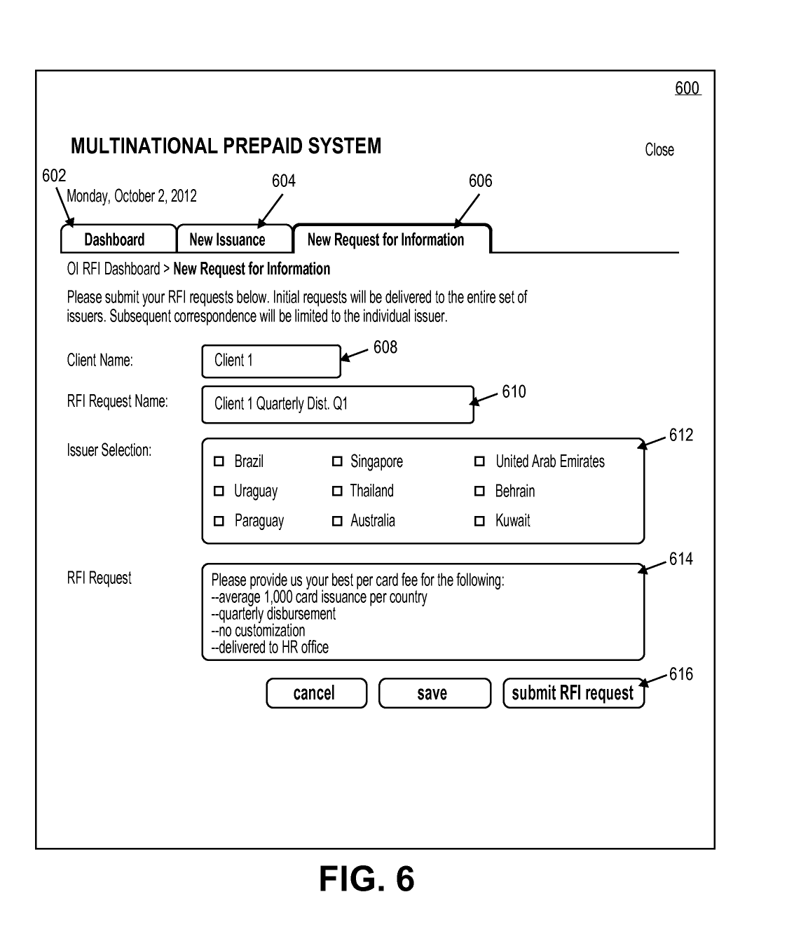

The server computer 106B may be configured to receive an RFI request 116 from the originating issuer 104. For example, the originating issuer 104 (e.g., an employee or third party agent managing the program on behalf of the originating issuer) may login into a web application provided by the multinational prepaid system 106 using the SSO 112. In some embodiments, a new request for information may be submitted by the originating issuer 104 to a plurality of destination issuers associated with different countries (or currencies) using a graphical user interface (e.g., an OI dashboard), as discussed below in reference to FIG. 6. The request for information may include a request to provide a per card fee for issuance of a certain number of cards in a destination country. Any other fee structure may be used as well (e.g., a flat rate, tiered, recurring, etc.).

The server computer 106B may be configured to generate an RFI request notification 118 after receiving the RFI request 116. In some embodiments, the RFI request notification 118 may provide an alert to each of the destination issuers 108A, 108B and 108C. In some embodiments, the alert may be an email, a text, a phone call or any suitable medium to notify the destination issuers 108 that an RFI request may be pending.

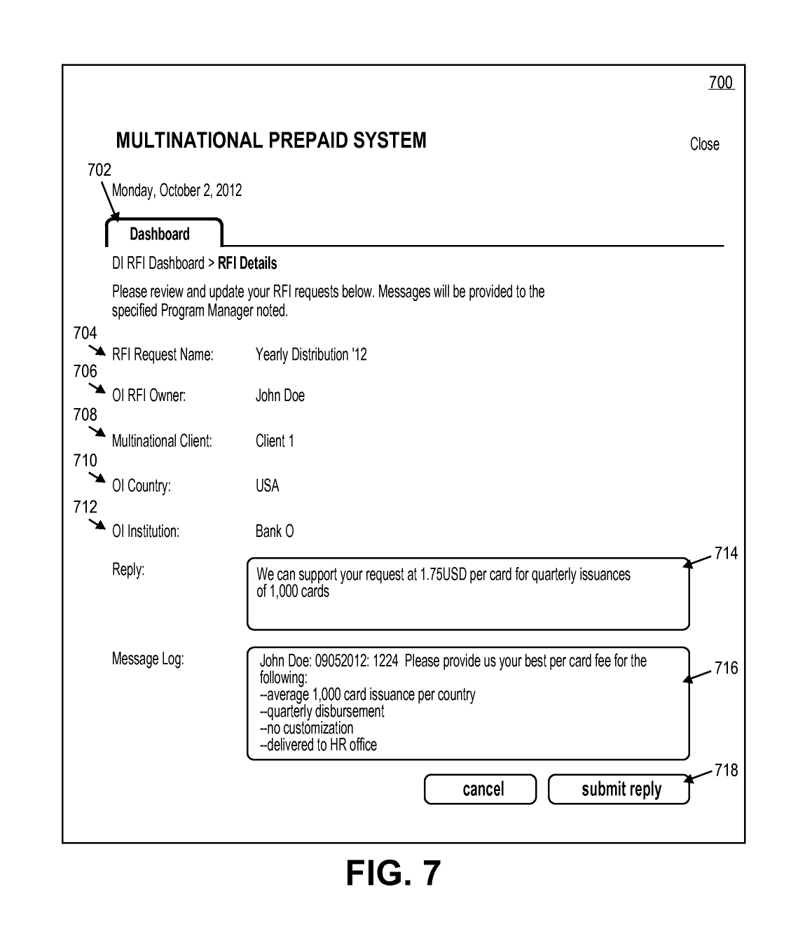

The destination issuers 108 may provide an RFI response 120 after receiving the RFI request notification 118. For example, each of the destination issuers 108A, 108B and 108C may login to the multinational prepaid system 106 using their respective SSO 114 process. Each of the destination issuers 108A, 108B and 108C may be presented with a graphical user interface (e.g., a destination issuer (DI) dashboard) after their successful login attempt into the multinational prepaid system 106, as discussed below in reference to FIG. 7. Each of the destination issuers 108A, 108B and 108C may provide their rate for issuance of a certain number of cards (or other costs associated with performing the requested card program) and submit their RFI response 120 using the web application provided by the multinational prepaid system 106.

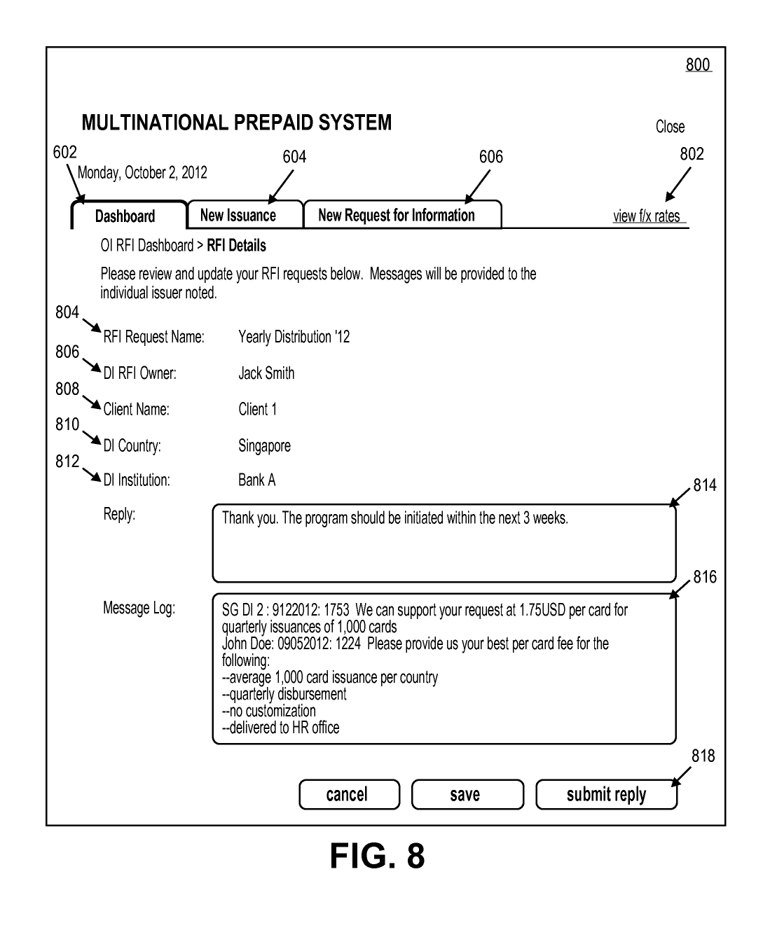

The originating issuer 104 may provide an RFI reply 124 in response to an RFI response notification 122, as discussed below in reference to FIG. 8. For example, the originating issuer 104 may acknowledge the RFI response from each destination issuer and indicate a timeline when the program may be started. Alternatively, the originating issuer 104 may negotiate the pricing for card issuance with a destination issuer before indicating a timeline.

The server computer 106B may generate a RFI reply notification 126 to each of the destination issuers 108A, 108B and 108C. For example, an email, a text, a SMS message or any other suitable alert message may be provided to the respective destination issuer (or the program manager or third party agent managing the program on behalf of the destination issuer) to notify the destination issuer that a RFI reply 124 may be pending. Each of the destination issuers 108A, 108B and 108C may login to the multinational prepaid system 106 to view the RFI reply 124 posted by the originating issuer 104. This process may be repeated until an agreement can be made between the originating issuer 104 and the respective destination issuers 108. Further, each destination issuer 108A-108C may separately negotiate the costs and terms of the prepaid multinational program.

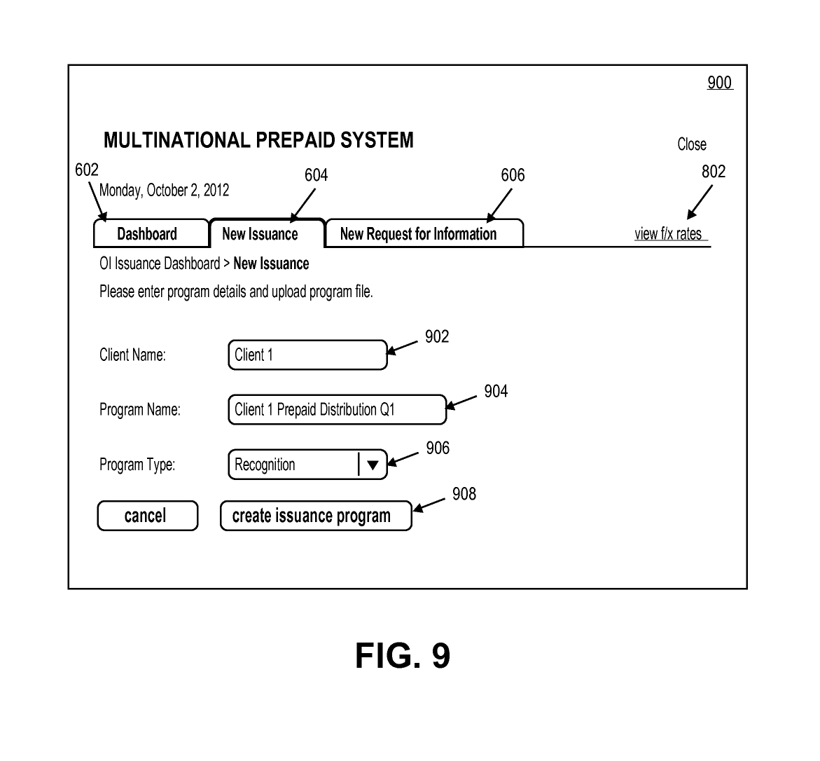

The originating issuer 104 may submit a program creation request 128 to the multinational prepaid system 106. For example, the originating issuer 104 may create an issuance program, as discussed below in reference to FIG. 9. The issuance program may be created for a client (e.g., multinational client 102) and may have a program name and a program type associated with it.

The originating issuer 104 may perform a OI card file upload 130 to the multinational prepaid environment. For example, the card file may be uploaded to the multinational prepaid system 106 using a SFTP protocol or other secure communications system in order to ensure the sensitive information within the card file is protected. In some embodiments, a card file may be uploaded to the multinational prepaid system 106 using an external file exchange server (not shown). If there is an error in uploading the card file or while the card file is being uploaded, an appropriate message may be displayed on the OI dashboard. The card file may include but is not limited to a card program identifier (e.g., a funding identifier), card activation information, fund recipient personal information (e.g., names, addresses, recipient personal identification numbers (PINs), identifiers, etc.), destination countries for each fund recipient, issuance amounts for each fund recipient, card value currency indicator, and/or any other relevant information to identifying and completing a fund transfer to fund recipients within destination countries.

The server computer 106B may be configured to split the card file (also referred to as an originating card file) into a plurality of destination card files, where each of the destination card files may include information associated with one or more fund recipients. The server computer 106B may split the card file by parsing and aggregating recipient information into a number of records associated with each country, currency, region, or other identifiable information to determine the appropriate destination issuer. The server computer 106B may associate each aggregated number of records based on country, currency, region, etc., with a particular destination issuer and may generate a plurality of destination card files where each destination card file is associated with a separate destination issuer. For example, a destination card file for country A may include all the records associated with the one or more fund recipients residing or presently located in country A, a destination card file for country B may include all the records associated with the one or more fund recipients in the country B and so on. Any relevant information may be used to group, aggregate, and split the received originating card file into multiple destination card files associated with multiple destination issuers. Each destination issuer may be associated with one or more fund recipients in order to have a destination card file generated for them.

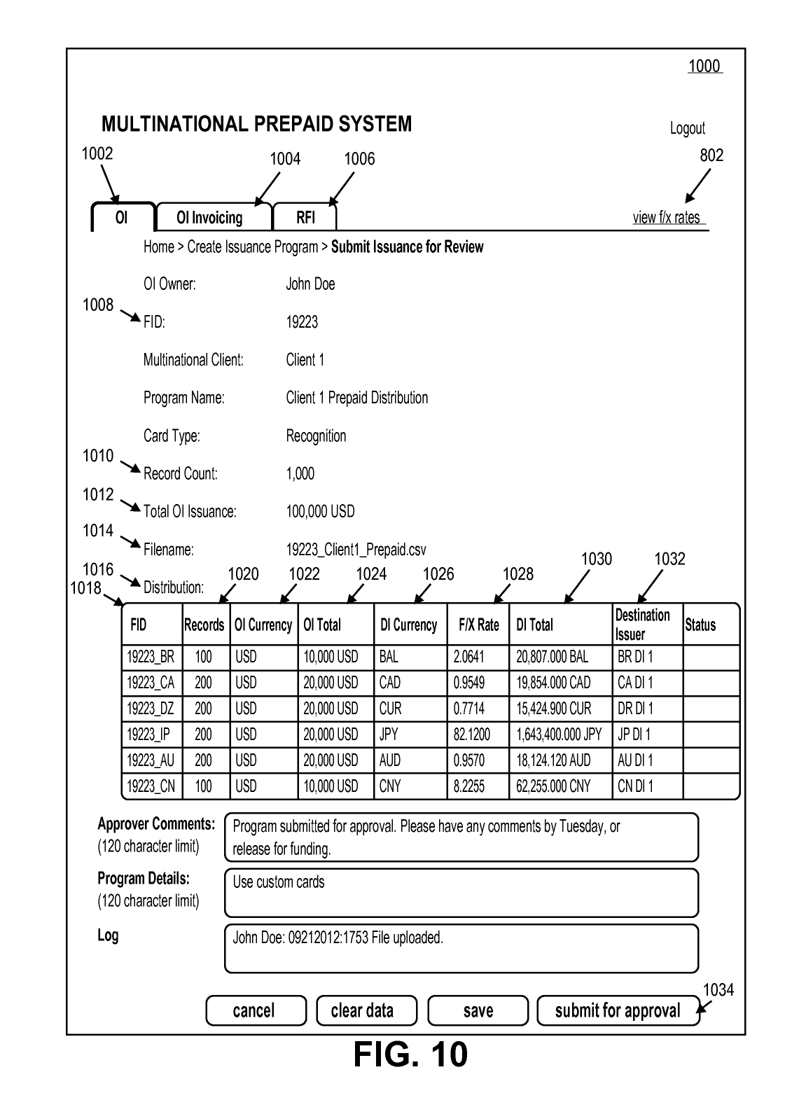

The originating issuer 104 may submit the prepaid program for approval 132 to the multinational prepaid system 106, as discussed below in reference to FIG. 10. The server computer 106B may determine if the program can be approved and released for funding based on a primary approver associated with the originating issuer 104. In some embodiments, the multinational prepaid system 106 may generate a secondary approval request 134 for the originating issuer 104. The secondary approval may be associated with the program manager (e.g., a third party agent charged with managing the disbursement program) associated with the third party originating issuer. In some embodiments, the primary and secondary approvals may be reconciled before submitting the program for funding.

Once the issuance program has been approved, the program may be released for funding. The server computer 106B may send a funding notification 136 to each of the destination issuers 108A, 108B and 108C confirming the approval and providing the terms of the program. The server computer 106B may also provide issuance data 138 to each of the destination issuers 108A, 108B and 108C related to fund recipients associated with each destination issuer 108A-108C. For example, the issuance data 138 for each country may include a total number of recipients (e.g., a record count), an amount per card in destination currency (could be the same or different for each recipient), and an f/x rate (so that the destination issuers may determine the amount paid in the originating currency for reporting purposes). The issuance data may be provided in any number of formats, for example, in some embodiments, the amount of prepaid funds may be provided in a total amount of funds to be received for the program.

The server computer 106B may be configured to generate a funding file 152 (also referred to as a issuance funding file) that may include foreign exchange rates for each of a plurality of currencies associated with the different destination issuers and a plurality of values in an originating currency wherein each value of the plurality of values is associated with a destination card file in the plurality of destination card files. In some embodiments, the foreign exchange rates may be locked in when the program is submitted for funding. The funding file may also include account information associated with the originating issuer 104 and the destination issuers 108. The server computer 106B may send the funding file to the funds transfer system 110 to initiate a plurality of fund transfers to the destination issuers 108. In some embodiments, the funding file may be encrypted before sending to the funds transfer system 110.

The server computer 106B may also be configured to provide the plurality of destination card files to the destination issuers 108 via a destination issuer (DI) card file transfer 150. For example, each of the destination issuers 108A, 108B and 108C may download their respective destination card file from the multinational prepaid system 106. The destination card files 138 for each destination issuer may include recipient information for each recipient that the destination issuer may issue prepaid funds to, a total number of recipients, an amount per card in destination currency (could be the same or different for each recipient), and an f/x rate (so that the destination issuers may determine the amount to be disbursed to each recipient). The issuance data may be provided in any number of formats, for example, in some embodiments, the amount of prepaid funds to provide to each recipient may already include the final total for each recipient after the f/x rate has been applied. In some embodiments, each destination card file may include fund recipient names, fund recipient addresses, fund recipient identifiers, fund recipient PINs, and fund recipient issuance amounts, etc. Each destination card file may also be associated with a country code identifier.

The server computer 110A may be configured to transfer a plurality of funds 154 in an originating currency from an account associated with the originating issuer 104 to an account associated with each destination issuer 108A, 108B and 108C, in their respective country's currencies. Each of the destination issuers 108A, 108B and 108C may provide a portion of the transferred funds to each of the fund recipients associated with the received destination card files as prepaid funds. For example, each of the destination issuers 108A, 108B and 108C may issue prepaid cards in their respective destination country currency for the amounts specified in their respective destination card file. The amount of funds issued to each recipient may or may not be the same. The prepaid cards may be mailed to the cardholder's address as specified in the destination card file or sent to the local office of the multinational client 102 for distribution. Any other method of disbursement may be used including personal pick up at the respective destination issuer by a fund recipient.

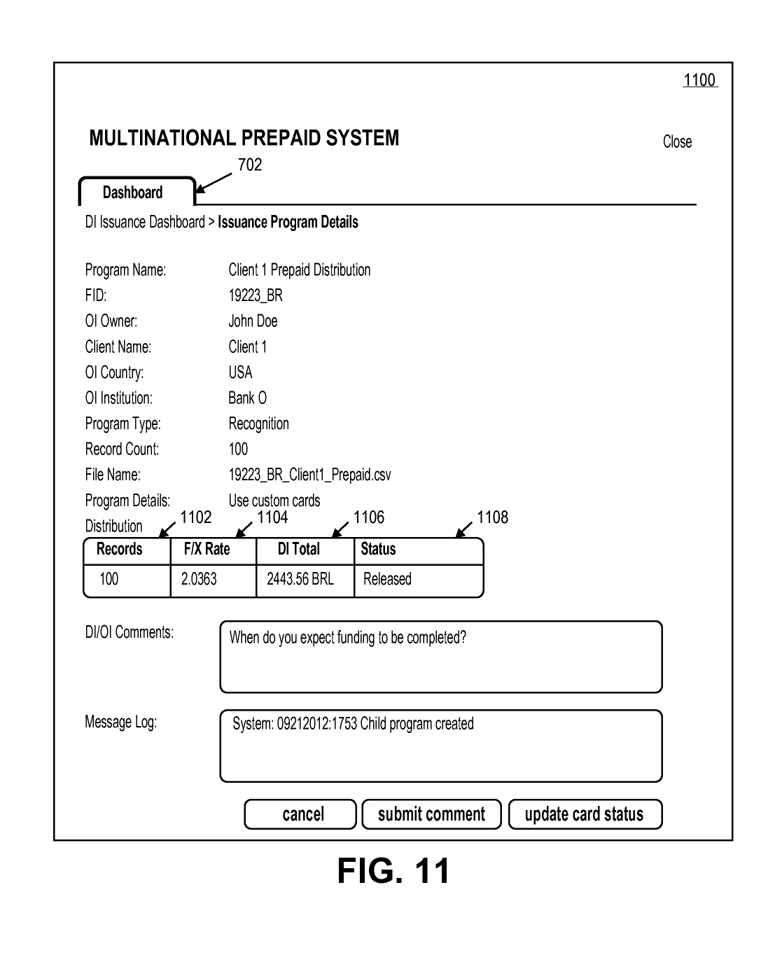

Each of the destination issuers 108A, 108B and 108C may send an issuance confirmed message 140 to the multinational prepaid system 106 once the cards are issued, as discussed below in reference to FIG. 11. The server computer 106B may send an issuance notification 142 to the originating issuer 104. For example, an email, a text, a SMS message or any other suitable alert message may be provided to the originating issuer 104 (e.g., the program manager) to notify that the funds have been issued in the destination countries.

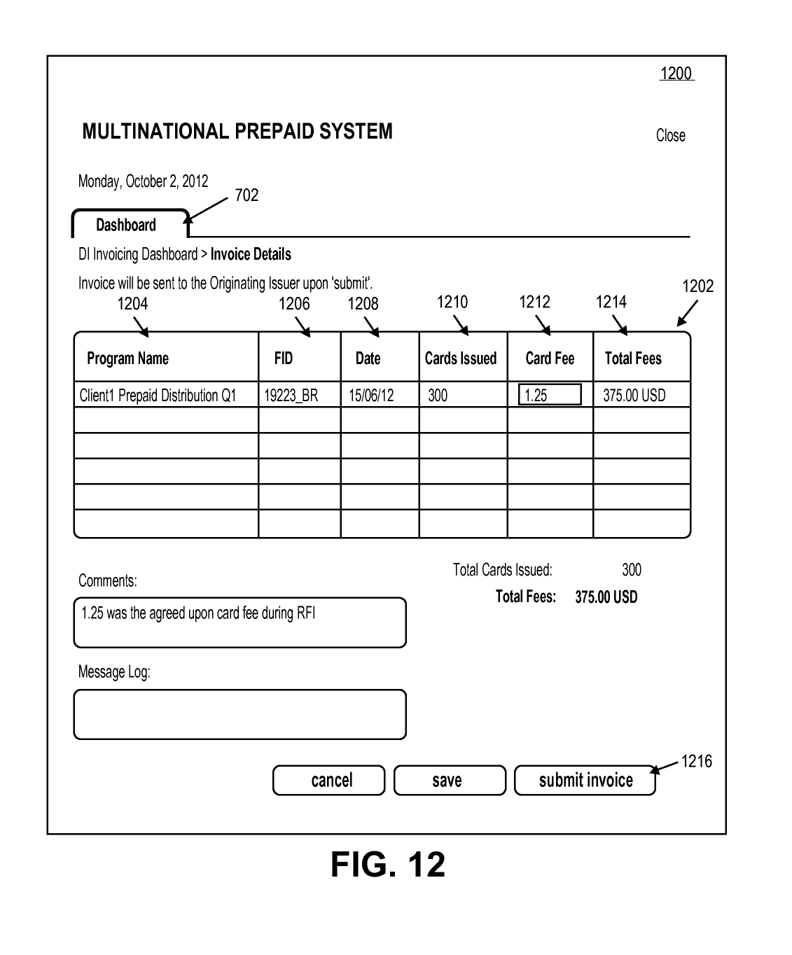

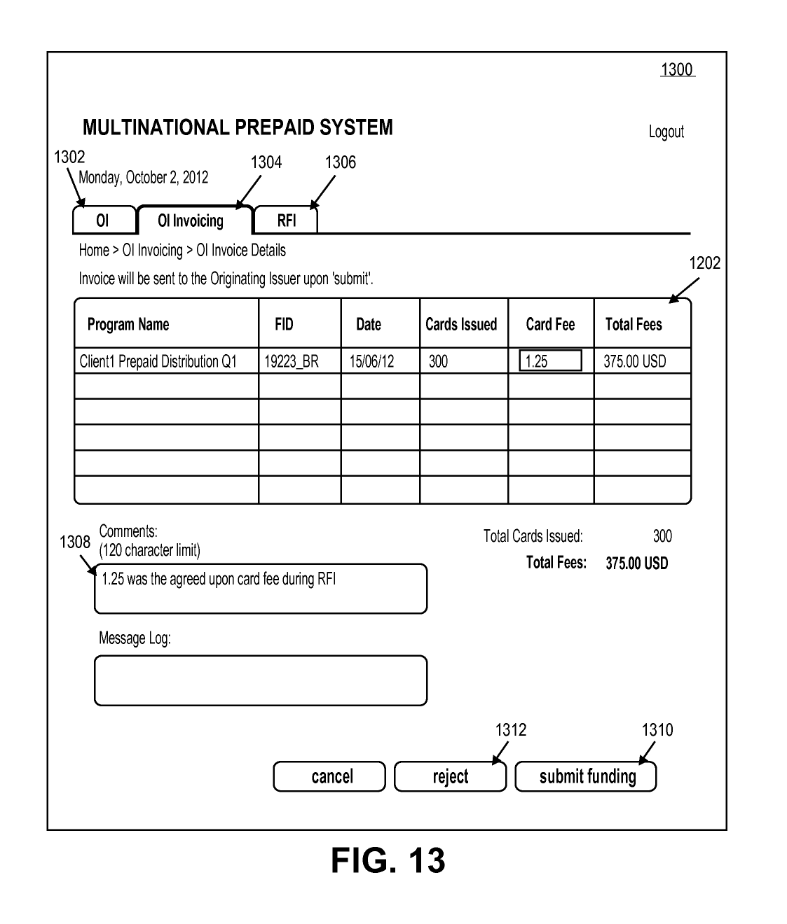

Each of the destination issuers 108A, 108B and 108C may generate and send an invoice 144 to the multinational prepaid system 106. As discussed below in reference to FIG. 12, the invoice may subsequently be submitted to the originating issuer 104. For example, an invoice notification 146 may be generated by the server computer 106B and sent to the originating issuer 104. In some embodiments, the originating issuer 104 and each of the destination issuers 108A, 108B and 108C may exchange comments to reconcile the pricing, terms, etc., before funding for the invoice can be released. Once the originating issuer has reviewed the invoice, the originating issuer 104 may send an invoice funding release message 148 to the multinational prepaid system 106. As discussed below in reference to FIG. 13, the originating issuer 104 may submit the invoice for funding to each of the destination issuers 108A, 108B and 108C.

Referring back to FIG. 1, a funding file 152 may be provided to the funds transfer system with invoice funding data. The invoice funding file 152 may include exchange information for each of the plurality of destination card files. The server computer 110A may initiate trading of the invoice funds from the originating currency into specified foreign currencies and transfer the invoice funds in foreign currencies to the respective destination issuers 108A, 108B and 108C. This process may be similar to the funding file processing and funds exchange provided during issuance funding. Additionally, in some embodiments, both the issuance funding file and the invoice funding file may be combined and a single transfer process may be accomplished for both aspects of the multinational prepaid program. Accordingly, although only one funding file is shown in FIG. 1, the funding file may include an issuance funding file, an invoice funding file, or a funding file including both. Therefore, a funding file may be sent to the funds transfer system multiple times (e.g., one for issuance and one for invoicing).

In some embodiments, an exchange computer (not shown) may be configured to include the functionality and processes of both the server computer 106B of the multinational prepaid system and the server computer 110A of the funds transfer system. For example, the exchange server computer (not shown) may be configured to receive the card file from an originating issuer computer associated with the originating issuer 104 and split the card file into a plurality of destination card files. Each of the destination card files may include information associated with one or more of the plurality of fund recipients. The exchange server computer may provide the plurality of destination card files to a plurality of destination issuer computers associated with a plurality of destination issuers 108A, 108B and 108C and transfer a plurality of funds to the plurality of destination issuers 108A, 108B and 108C from the originating issuer 104.

The exchange server computer may further be configured to receive a plurality of invoices from the plurality of destination issuer computers associated with issuing the prepaid funds and transfer a plurality of invoice funds to the plurality of destination issuers 108A, 108B and 108C from the originating issuer 104. Accordingly, the steps described in reference to FIG. 1 may be accomplished by any number of different entities within a funds transfer system.

FIG. 2 illustrates a funds transfer process 200 in accordance with an embodiment of the invention. The funds transfer process 200 may include entities similar to those described above in reference to FIG. 1.

As illustrated in the figure, at step 201, a multinational client 102 may request that bank O 202 provide prepaid card issuance in destination countries A and B.

At step 203, the originating issuer 104 may send a funding request to the multinational prepaid system 106. For example, as discussed with reference to FIG. 1, the originating issuer 104 may send the submit for approval 132 message to the multinational prepaid system 106. Once the issuance program has been approved, the program may be released for funding. In some embodiments, the primary and secondary approvals may be reconciled before submitting the program for funding.

At step 205, the server computer 106B associated with the multinational prepaid system (MPS) 106 may split the card file into a plurality of destination card files such as card issuance data file A and card issuance data file B and may send the respective destination card files to the respective destination issuers 204, 208. In one embodiment, the card issuance data file A may include fund recipient information for one or more fund recipients located or residing in destination country A and the card issuance data file B may include fund recipient information associated with fund recipients located or residing in destination country B.

At step 207, the multinational prepaid system 106 may provide a funding file (e.g., funding file 152) to the funds transfer system 110 which may include aggregated funding data by currency. In one embodiment, the funding file 152 may include for each destination country a funding identifier, number of prepaid cards to be issued, the originating country currency and the total funds, the destination country currency and the totals funds, f/x rate, and the destination issuer identification.

The trading platform 212 may be a third party entity that may provide a platform for settlement of international transactions as well as up to date foreign exchange rates. In one embodiment, the foreign exchange rates may be provided by the funds transfer system 110 to the multinational prepaid system 106 to generate funding data associated with different destination issuers in different currencies.

At step 209, the funds transfer system 110 may provide funds transfer instructions to the originating issuer 104 and a financial institution 216 so that the funds can be transferred for trading from an originating issuer account 214 in the originating country currency on a particular value date to trading accounts associated with the financial institution 216. In some embodiments, the funds transfer instructions may include information associated with the funding file provided by the multinational prepaid system 106 such as a settlement system identifier for settlement of the funds between different currencies and account information including account identifiers for transfer of funds among different issuers.

At step 211, in some embodiments, the funds in the originating country currency can be traded using the trading accounts associated with the financial institution 216 into a destination country currency using trading counterparty bank accounts associated with a financial institution 218. In some embodiments, the trading accounts may be associated with a payment processing network such as VisaNet®. The trading platform 212 may provide the trading details (e.g., rates, costs, etc., for each transfer) and organize the respective transfers surrounding the settlement of trading funds. Thereafter, at the predetermined time (e.g., one or more days later) of the value date, the originating country currency funds transfer, each of the respective currency trades, and each of the destination country currency funds transfers, may be completed on the value date for each country. For example, using the trading accounts associated with the financial institution 216, the destination country A currency funds may be transferred on value date to the destination issuer A account 220 and the destination country B currency funds may be transferred on value date to the destination issuer B account 222.

At step 213, once the funds in the respective destination currencies are transferred to each destination issuer, each destination issuer can issue prepaid cards in their destination country to the fund recipients specified in the respective card issuance data file. For example, bank A 204 may issue prepaid cards in destination country A currency to fund recipients 206 in the destination country A and bank B 208 may issue prepaid cards in destination country B currency to fund recipients 210 in the destination country B.

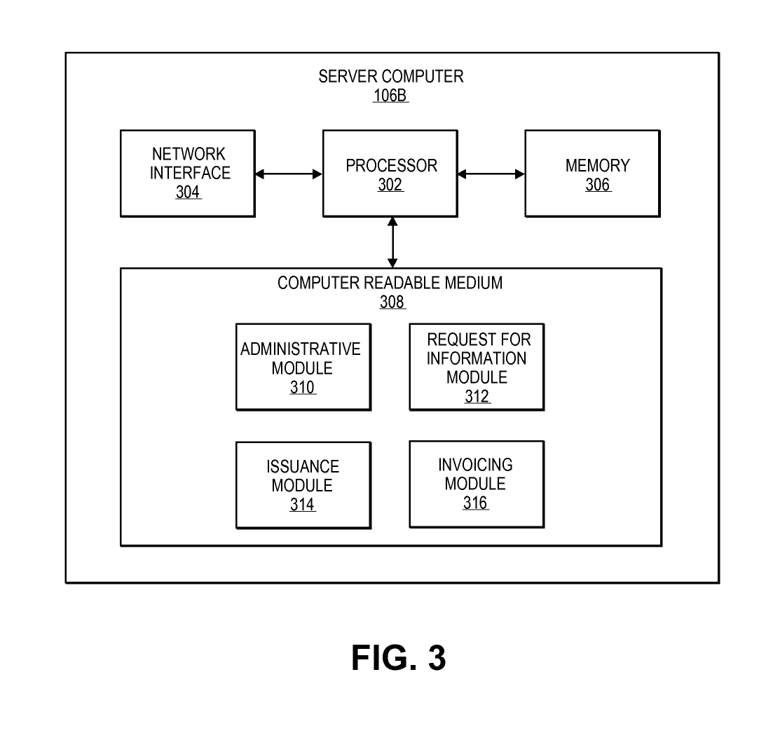

FIG. 3 illustrates some components of the server computer 106B in one embodiment of the invention.

As illustrated in FIG. 3, the server computer 106B may include a processor 302 communicatively coupled to a network interface 304, a memory 306 and a computer readable medium 300. In one example, the server computer 106B may be a database server coupled to a web server. The server computer 106B may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The network interface 304 may be configured to communicate with the originating issuer 104, destination issuers 108, the funds transfer system 110 and other entities (not shown) using one or more communications networks.

The memory 306 may include volatile (SRAM, DRAM, etc.) and/or non-volatile memory (e.g., ROM, flash memory, magnetic devices, optical discs, etc.). In some embodiments, the memory 306 may include a non-volatile, non-writable storage area (e.g., Flash ROM) where the firmware/operating system may reside. In some embodiments, the memory 306 may include RAM where volatile run-time memory may reside.

The computer readable medium (CRM) 300 may be in the form of a memory (e.g., flash, ROM, RAM, etc.) and may comprise code, executable by the processor 302 for implementing methods described herein. For example, the computer readable medium 300 may include code implementing an administrative module 310, a request for generation module 312, an issuance module 314, and/or an invoicing module 316.

The administrative module 310 may be configured to allow registration of the originating issuer 104 and the destination issuers 108 with the multinational prepaid service implemented by the multinational prepaid system 106. For example, each of the program managers associated with the originating issuer 104 and the destination issuers 108 may setup an account with the multinational prepaid system 106 to access the one or more applications implementing the multinational prepaid service. In some embodiments, the administrative module 310 may be configured to verify the access privileges associated with each program manager (for both originating and destination issuers). The administrative module 310 may also be configured to allow uploading and downloading files such as card files, rate files, funding files, etc., to the multinational prepaid system 106. In some embodiments, the administrative module 310 may communicate with an external server associated with a file exchange service for uploading/downloading files.

The request for information module 312 may be configured to receive RFI requests and RFI reply from the originating issuer 104 and provide RFI request and RFI reply notifications to each of the destination issuers 108A, 108B and 108C. Additionally, the request for information module 312 may be configured to receive RFI response messages from each of the destination issuers 108A, 108B and 108C and provide RFI response notification to the originating issuer 104. For example, an alert message may be generated for the originating issuer 104 and the destination issuers 108 to notify them that an item needs attention.

The issuance module 314 may be configured to split the card file into a plurality of destination card files and provide issuance data to each of the destination issuers 108A, 108B and 108C. The issuance module 314 may also be configured to generate a funding file with aggregated funding data by currency to provide to the funds transfer system 110 for trading and transferring the prepaid funds to various destination issuers. In some embodiments, the issuance module 314 may use a rate file provided by the funds transfer system 110 or by a third party to determine a plurality of values in each destination currency based on an exchange rate provided by the rate file and a plurality of values in an originating currency provided by the card file.

The invoicing module 316 may be configured to receive a plurality of invoices from each of the destination issuers 108 and provide an invoice notification to the originating issuer 104. The invoicing module 316 may further be configured to generate an invoice funding file based on the plurality of invoices to provide to the funds transfer system 110 for trading and transferring the invoice funds to various destination issuers for their prepaid services. In some embodiments, the invoicing module 316 may use a rate file provided by the funds transfer system 110 or by a third party to determine a plurality of values in each destination currency based on an exchange rate provided by the rate file and different invoice amounts in an originating currency provided by different destination issuers.

In some embodiments, the funding file generated for transfer of prepaid funds and for the invoice funds may include the same file format. For example, a field in the funding file may differentiate the file type to be either associated with issuance or invoicing. In some embodiments, each funding file may include a time stamp to indicate a date and time the file was created, effective rate period for exchange rates, a transaction identifier, a settlement system identifier, a currency code to indicate the originating issuer currency or the destination issuer currency, a currency amount to indicate the originating issuer currency amount or the destination issuer currency amount and a record count.

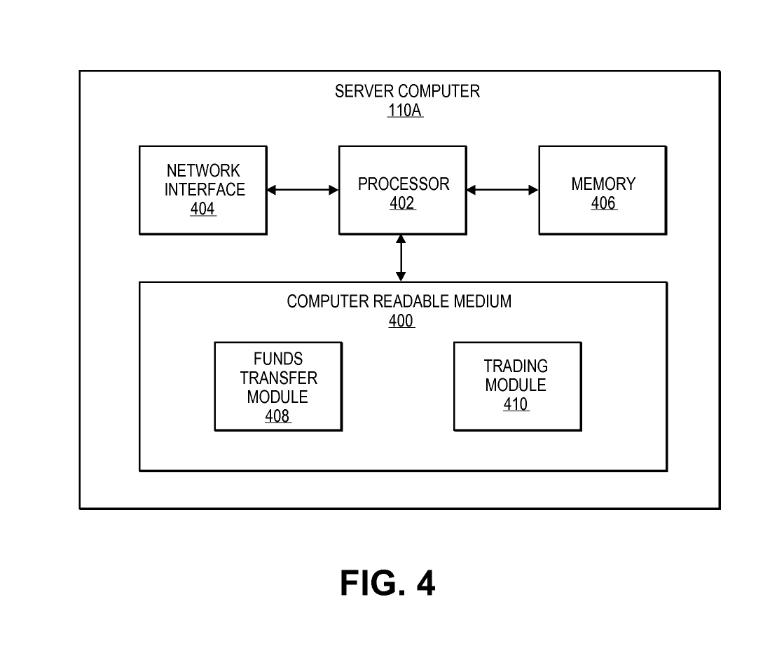

FIG. 4 illustrates some components of the server computer 110A in one embodiment of the invention. The server computer 110A may include a processor 402 communicatively coupled to a network interface 404, a memory 406 and a computer readable medium 400.

The network interface 404 may be configured to communicate with the multinational prepaid system 106, the trading platform 212, the financial institution 216 and any other entities (not shown) using one or more communications networks.

The memory 406 may include volatile (SRAM, DRAM, etc.) and/or non-volatile memory (e.g., ROM, flash memory, magnetic devices, optical discs, etc.). In some embodiments, the memory 406 may include a non-volatile, non-writable storage area (e.g., Flash ROM) where the firmware/operating system may reside. In some embodiments, the memory 406 may include RAM where volatile run-time memory may reside.

The computer readable medium (CRM) 400 may be in the form of a memory (e.g., flash, ROM, RAM, etc.) and may comprise code, executable by the processor 402 for implementing methods described herein. For example, the computer readable medium 400 may include code implementing a funds transfer module 408 and/or a trading module 410.

The funds transfer module 408 may be configured to receive a funding file from the multinational prepaid system 106. The funds transfer module 408 may also be configured to provide fund transfer instructions to initiate transfer of funds in the originating country currency from the originating issuer bank account 214 to the trading accounts associated with the financial institution 216 using the funding file.

The trading module 410 may be configured to receive a rate file including foreign exchange rates from the trading platform 212 and provide the rate file to the multinational prepaid system 106. The trading module 410 may also be configured to initiate transfer of funds in a plurality of destination country currencies using the trading platform 212 from the trading accounts associated with the financial institution 216 to the plurality of destination issuers.

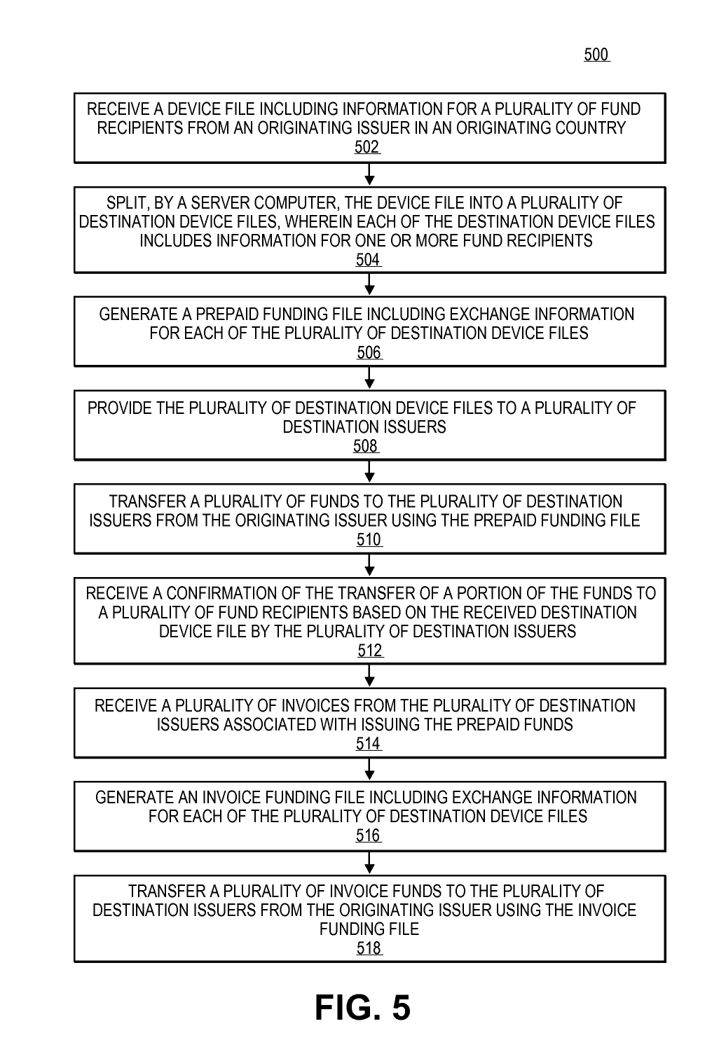

FIG. 5 illustrates an exemplary flow chart 500 illustrating a method for implementing some embodiments of the invention.

In step 502, a device file is received from an originating issuer in an originating country, wherein the device file includes information for a plurality of fund recipients. For example, the server computer 106B may receive a card file from the originating issuer 104 after the prepaid program is approved (e.g., after the RFI process). The card file may include information such as the contact information of the fund recipients, a program identifier, a client identifier, issuance card amounts and expiration dates, etc.

In step 504, the server computer 106B may split the device file into a plurality of destination device files, wherein each of the destination device files may include recipient information for one or more fund recipients. For example, the server computer 106B may split the card file into card issuance data file A and card issuance data file B as shown in FIG. 2. Each of the destination card file may include information associated with the fund recipients in their destination country. For example, the card issuance data file A may include information associated with the fund recipients in the destination country A and the card issuance data file B may include information associated with the fund recipients in the destination country B.

In step 506, the server computer 106B may generate a prepaid funding file including exchange information for each of the plurality of destination device files. Referring back to FIG. 2, the server computer 106B may generate a prepaid funding file including aggregated funding data by currency. For example, the prepaid funding file may include funding data for fund recipients in destination country A currency and funding data for fund recipients in destination country B currency and so on. The funding data for each destination country may include an originating issuer currency code, a destination issuer currency code, an exchange rate, currency amounts, a transaction identifier, etc.

In step 508, the server computer 106B may provide the plurality of destination device files to a plurality of destination issuers. Referring back to FIG. 2, the server computer 106B may provide the card issuance data file A to the destination issuer 108A and the card issuance data file B to the destination issuer 108B. In some embodiments, the destination issuer 108A and the destination issuer 108B may receive the respective destination card file using the destination issuer (DI) card file transfer 150 as shown in FIG. 1.

In step 510, a plurality of funds from the originating issuer may be transferred to the plurality of destination issuers using the prepaid funding file. Referring back to FIG. 2, the plurality of funds may be transferred from the originating issuer bank account 214 in the originating country currency on value date to the destination issuer A bank account 220 in the destination country A currency on value date and to the destination issuer B bank account 222 in the destination country B currency on value date.

In step 512, a confirmation of the transfer of a portion of the funds to a plurality of fund recipients based on the received destination device file by the plurality of destination issuers may be received. For example, the destination issuer 108A may transfer a portion of the funds to the fund recipients in the destination country A based on the card issuance data file A and the destination issuer 108B may transfer a portion of the funds to the fund recipients in the destination country B based on the card issuance data file B and so on. In some embodiments, the destination issuer A may issue prepaid cards to the fund recipients in country A in the country A currency and the destination issuer B may issue prepaid cards to the fund recipients in country B in the country B currency.

In step 514, a plurality of invoices from the plurality of destination issuers associated with issuing the prepaid funds are received. Referring back to FIG. 2, the destination issuer 108A may provide an invoice for issuance of the prepaid funds in country A and the destination issuer 108B may provide an invoice for issuance of the prepaid funds in country B to the server computer 106B.

In step 516, an invoice funding file may be generated that may include exchange information for each of the plurality of destination device files. For example, the server computer 106B may generate an invoice funding file that may include foreign exchange rate associated with each destination currency, a plurality of values in an originating currency and an account information associated with the originating issuer 104 and the plurality of destination issuers 108A, 108B and 108C.

In step 518, a plurality of invoice funds may be transferred to the plurality of destination issuers from the originating issuer using the invoice funding file. Referring back to FIG. 2, the plurality of invoice funds may be transferred from the originating issuer bank account 214 in the originating country currency on value date to the destination issuer A bank account 220 in the destination country A currency on value date and to the destination issuer B bank account 222 in the destination country B currency on value date.

In some embodiments, the method implemented by the flow chart 500 may be performed by an exchange server computer. In some embodiments, the exchange server computer may be associated with a payment processing network such that the exchange server computer may use pre-existing relationships and funds transfer infrastructure established with issuers throughout the world.

The payment processing network may include data processing subsystems, networks, and operations used to support and deliver authorization services, exception file services, and clearing and settlement services. For example, the payment processing network may comprise a server computer and databases of information. An exemplary payment processing network may include, for example, VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

FIG. 6 illustrates a screen shot 600 displaying a user interface to submit a new request for information, in one embodiment of the invention.

As shown in FIG. 6, the originating issuer 104 may be presented with options to select a dashboard 602, a new issuance 604 or a new request for information (RFI) 606. In some embodiments, the originating issuer 104 may need to successfully log into the multinational prepaid system 106 to get to the screen 600.

A client name 608 may represent the name of the multinational client 102. In some embodiments, the dashboard 602 may allow searching for the client name 608. A request for information (RFI) request name 610 may represent an incentive program name for the particular client. For example, the RFI request name 610 may represent a prepaid card program for client 1's quarterly distribution for the first quarter.

An issuer selection window 612 may allow the originating issuer 104 to select one or more destination issuers for submitting the RFI request. An RFI request message 614 may include a request for information from the destination issuers 108. For example, the RFI request message 614 may include an enquiry about the rates offered by each destination issuer for issuing 1000 prepaid cards quarterly in their respective location. A submit RFI request button 612 may allow the originating issuer 104 to submit the RFI request 614 to one or more issuers as selected in the issuer selection window 612.

FIG. 7 illustrates a screen shot 700 displaying a user interface for submitting an RFI response by a destination issuer, in one embodiment of the invention. As illustrated in FIG. 7, a dashboard 702 may allow each of the destination issuers 108 to view a message log 716 submitted by the originating issuer 104 in the RFI request 614. The dashboard 702 may further allow each of the destination issuers 108 to view an RFI request name 704, an originating issuer (OI) RFI owner 706, a multinational client 708, an OI country 710 and an OI institution 712. For example, the RFI request name 704 may represent “yearly distribution 2012” for “client 1” initiated by a “Bank 0” in the originating country “USA”. In one embodiment, the RFI owner 706 may be a program manager associated with the OI institution 712 (e.g., the program manager 104A).

The destination issuers 108 may provide a reply 714 to the RFI request as shown in the message log 716. For example, the destination issuer 108A may provide a rate per card for quarterly issuance of 1000 cards in country A, the destination issuer 108B may provide a rate per card for quarterly issuance of 1000 cards in country B and so on. The multinational prepaid system 106 may generate an RFI response notification 122 to the OI institution 712. For example, an email, a text or SMS message or any suitable alert may be sent to the OI RFI owner 706 to notify that an RFI response may be pending.

FIG. 8 illustrates a screen shot 800 displaying a user interface for submitting an RFI reply by an originating issuer, in one embodiment of the invention. As illustrated in FIG. 8, the dashboard 602 may allow the originating issuer 104 (e.g., the OI RFI owner 706) to view a message log 816 that includes the RFI response submitted by a destination issuer (DI) request for information (RFI) owner 806 (e.g., a DI project manager) associated with a DI institution 812 in a DI country 810 for a RFI request name 804 for a client name 808. The originating issuer 104 may provide a reply 814 to the respective destination issuer (e.g., the DI RFI owner 806). For example, the reply 814 may include a message indicating a time line for start of the card issuance project. A link 802 may allow the originating issuer 802 to view foreign exchange (f/x) rates designated for the DI institution 812.

FIG. 9 illustrates a screen shot 900 displaying a user interface for creating an issuance program by an originating issuer, in one embodiment of the invention. As illustrated in FIG. 9, the originating issuer 104 may select a client name 902, a program name 904 and a program type 906 on the OI issuance dashboard to create an issuance program 908. Referring back to FIG. 1, the program creation 128 may be submitted to the multinational prepaid system 106 by the originating issuer 104.

FIG. 10 illustrates a screen shot 1000 illustrating an originating issuer user interface for an issuance program, in one embodiment of the invention. As illustrated in FIG. 10, the originating issuer 104 dashboard may include selections for an OI 1002, an OI invoicing 1004 and an RFI dashboards. A financial identifier (FID) 1008 may provide a funding identifier associated with the prepaid program. A record count 1010 may represent total number of cards to be issued. A total OI issuance 1012 may represent funds in originating country currency that may be provided by client 1 (e.g., the multinational client 102) to the originating issuer 104. In some embodiments, the total OI issuance 1012 may be stored in the originating issuer account 214 as shown in FIG. 2. A filename 1014 may represent a card file including information associated with the fund recipients. For example, the card file may be uploaded to the multinational prepaid system 106 by the originating issuer 104 in OI card file upload 130. In some embodiments, the filename 1014 may include the FID 1008 to associate the card file to a particular prepaid program. The program may be submitted for approval 1034 by a primary approver associated with the OI owner (e.g., a program manager associated with the originating issuer 104). In some embodiments, a secondary approval may be required before the program may be released for funding.

A distribution 1016 illustrates a portion of a funding file including aggregated funding data by currency. For example, the funding file may include a FID 1018 associated with each destination issuer. In some embodiments the FID 1018 may correspond to the FID 1008 and may include a country code to associate the FID 1018 to a particular prepaid program. The funding file may also include records 1020 that may represent the total number of prepaid cards that may be issued in each country represented by the country code in the FID 1018. An F/X rate 1028 may represent an exchange rate for conversion of an OI total 1024 in an OI currency 1022 into a DI currency 1026. The OI total 1024 may represent a plurality of values in an originating currency (OI currency 1022).

Referring to FIG. 2, the funds transfer system 110 may transfer the OI total 1024 in the OI currency 1022 from the originating issuer account 214 into the trading accounts 216 and using the trading platform 212, may obtain an equivalent DI total 1030 in DI currency 1026 from the trading counterparty bank accounts 218 and transfer the DI total 1030 to each destination issuer 1032. Each destination issuer 1032 may use their respective destination card file to determine a portion of funds from the DI total 1030 assigned to each fund recipient and distribute the funds accordingly.

For example, as shown in FIG. 10, the FID 1018 equal to 19223_BR may represent a funding identifier for the prepaid program in the country Brazil. The OI total 1024 of 10,000 USD may have been assigned by the multinational client 102 to issue 100 prepaid cards (records 1020) in the DI currency 1026 equal to BAL. The funds transfer system 110 may convert the 10,000 USD into the 20,807.000 BAL using an exchange rate of 2.0641 (F/X rate 1028). The funds transfer system 110 may further transfer the 20,807.000 BAL to the destination issuer BR D1 to issue 100 prepaid cards to specified recipients in the destination card file.

FIG. 11 illustrates a screen shot 1100 illustrating issuer program details on the DI dashboard 702, in one embodiment of the invention. As illustrated in FIG. 11, records 1102 may represent the number of cards that have been released for issuance at an F/X rate 1104 with a DI total 1106. Referring back to FIG. 1, once the program is released for funding as indicated by the funding notification 136, the issuance program details may include information from the issuance data 138 provided by the multinational prepaid system 106.

FIG. 12 illustrates a screen shot 1200 illustrating a destination issuer dashboard for submitting invoice details, in one embodiment of the invention. As illustrated in FIG. 12, an invoice 1202 for a program name 1204 may include an FID 1206, a date 1208, cards issued 1210, a card fee 1212 and a total fees 1214. For example, the invoice 1202 may be generated by the destination issuer (BR DI1 as shown in FIG. 10) for issuance of 300 prepaid cards. The card fee 1212 may represent the fee charged by the destination issuer for each card that may have been agreed upon between the destination issuer and the originating issuer 104 during RFI exchange. The invoice 1202 may be sent to the originating issuer 104 upon selecting submit invoice 1216.

FIG. 13 illustrates a screen shot 1300 illustrating invoice details on the originating issuer's dashboard, in one embodiment of the invention. As illustrated in FIG. 13, the OI dashboard may include an OI 1302, an OI invoicing 1304 and an OI RFI 1306 user interfaces. The originating issuer 104 can reject the invoice 1202 by selecting reject 1312 or submit for funding by selecting submit funding 1310. The originating issuer 104 can provide comments 1308 if the originating issuer 104 decides to reject the invoice.

When the invoice 1202 is submitted for funding, an invoice creation message 144 may be sent to the multinational prepaid system 106, as shown in FIG. 1. The multinational prepaid system 106 may sent the invoice notification message 146 to the originating issuer 104 so the originating issuer 104 may release invoice funding as indicated by the invoice funding release message 148. The multinational prepaid system 106 may provide an invoice funding file to the funds transfer system 110 for conversion and transfer of the funds in the destination country currency to the appropriate destination issuer, as discussed with reference to FIG. 2.

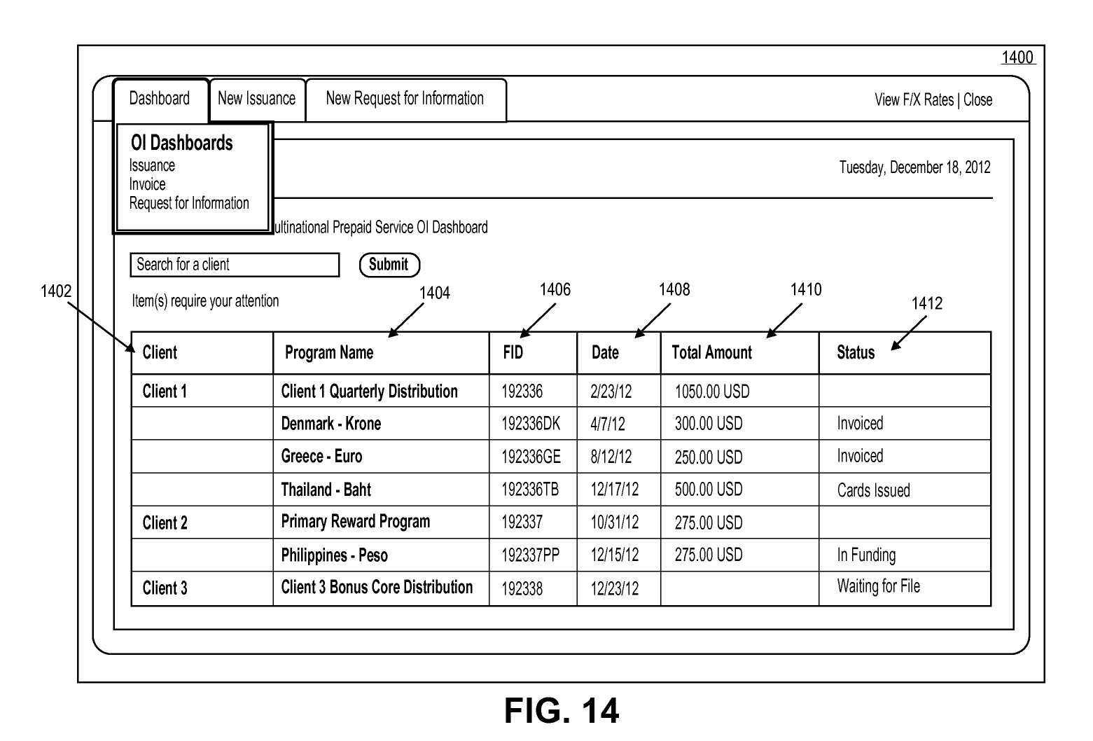

FIG. 14 illustrates a screen shot 1400 illustrating a high level user interface for the multinational prepaid system, in one embodiment of the invention. As illustrated in FIG. 14, for each client 1402, a program name 1404, an FID 1406, a date 1408, a total amount 1410 and a status 1412 may be displayed on the originating issuer's dashboard. As shown in the figure, a different FID may be associated with each client. At any given time, the multinational prepaid system 106 may provide multinational prepaid services to a plurality of clients. The status 1412 may indicate the status of the program for each client.

In some embodiments, the multinational prepaid system 106 may allow each destination issuer to view and access only certain components on the DI dashboard. For example, each destination issuer may only have access to information associated with their destination card file. In addition, none of the destination issuers may have access to components associated with the originating issuer dashboard.

Embodiments of the invention provide an efficient solution for multinational prepaid services by providing the recipient information and the funds from an originating issuer in an originating country to local (destination) issuers in various countries so that the local issuers in those countries may issue the prepaid cards in their local currency. Such multinational prepaid service enables a matrix of issuers connecting the originating issuer with a destination issuer (e.g., a foreign bank) and vice-versa, thus, eliminate the need for the issuers to manage the contractual logistics, funding, f/x (foreign exchange) management, and vendor management aspects of a multinational program. The destination issuers may issue the prepaid cards in their local currency, thus saving time and resources for the multinational client in implementing the multinational prepaid program.

FIG. 15 is a high level block diagram of a computer system that may be used to implement any of the entities or components described above. The subsystems shown in FIG. 15 are interconnected via a system bus 10. Additional subsystems include a printer 18, keyboard 26, fixed disk 28, and monitor 22, which is coupled to display adapter 20. Peripherals and input/output (I/O) devices, which couple to I/O controller 12, can be connected to the computer system by any number of means known in the art, such as a serial port. For example, serial port 24 or external interface 30 can be used to connect the computer apparatus to a wide area network such as the Internet, a mouse input device, or a scanner. The interconnection via system bus 10 allows the central processor 16 to communicate with each subsystem and to control the execution of instructions from system memory 14 or the fixed disk 28, as well as the exchange of information between subsystems. The system memory 14 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

What is claimed is:

1. A method of processing multinational prepaid funding transactions, the method comprising:
receiving a device file from an originating issuer in an originating country, the device file comprising recipient information for a plurality of fund recipients;
splitting, by a server computer, the device file into a plurality of destination device files, each of the destination device files including one or more of the plurality of fund recipients;
generating, by the server computer, a prepaid funding file including exchange information for each of the plurality of destination device files;
providing the plurality of destination device files to a plurality of destination issuers; and
transferring a plurality of funds to the plurality of destination issuers from the originating issuer using the prepaid funding file, wherein the plurality of destination issuers provide a portion of the transferred funds to each of the plurality of fund recipients associated with the received destination device file of the plurality of destination device files as prepaid funds.

2. The method of claim 1, wherein the plurality of destination device files correspond to a plurality of currencies.

3. The method of claim 1, wherein the plurality of destination device files correspond to a plurality of countries.

4. The method of claim 1, wherein the device file includes a card file.

5. The method of claim 3, wherein each of the plurality of funds are transferred in local currencies of the plurality of countries.

6. The method of claim 1, wherein transferring a plurality of funds to the plurality of destination issuers from the originating issuer using the prepaid funding file further comprises:
sending the prepaid funding file to a funds transfer system configured to transfer funds from the originating issuer to the plurality of destination issuers, wherein the funds transfer system is configured to use the prepaid funding file to initiate a plurality of fund transfers, each of the fund transfers associated with one of the plurality of destination issuers.

7. The method of claim 6, wherein the exchange information further comprises:
foreign exchange rates for each of a plurality of currencies,
a plurality of values in an originating currency, each value of the plurality of values being associated with each of the destination device files, and
account information associated with the originating issuer and the plurality of destination issuers.

8. The method of claim 1, further comprising:
after transferring the plurality of funds to the plurality of destination issuers, receiving a plurality of invoices from the plurality of destination issuers associated with issuing the prepaid funds;
generating, by the server computer, an invoice funding file including exchange information for each of the plurality of destination device files; and
transferring a plurality of invoice funds to the plurality of destination issuers from the originating issuer using the invoice funding file.

9. A server computer comprising:
a processor;
a computer readable medium coupled to the processor, the computer readable medium comprising code, executable by the processor for implementing a method of processing multinational prepaid funding transactions, the method comprising:
receiving a device file from an originating issuer in an originating country, the device file comprising recipient information for a plurality of fund recipients;
splitting the device file into a plurality of destination device files, each of the destination device files including one or more of the plurality of fund recipients;
generating a prepaid funding file including exchange information for each of the plurality of destination device files;
providing the plurality of destination device files to a plurality of destination issuers; and
transferring a plurality of funds to the plurality of destination issuers from the originating issuer using the prepaid funding file, wherein the plurality of destination issuers provide a portion of the transferred funds to each of the plurality of recipients associated with the received destination device file of the plurality of destination device files as prepaid funds.

10. The server computer of claim 9, wherein the plurality of destination device files correspond to a plurality of currencies.

11. The server computer of claim 9, wherein the plurality of destination device files correspond to a plurality of countries.

12. The server computer of claim 9, wherein the device file includes a card file.

13. The server computer of claim 11, wherein each of the plurality of funds are transferred in local currencies of the plurality of countries.

14. The server computer of claim 9, wherein transferring a plurality of funds to the plurality of destination issuers from the originating issuer using the prepaid funding file further comprises:
sending the funding file to a funds transfer system configured to transfer funds from the originating issuer to the plurality of destination issuers, wherein the funds transfer system is configured to use the funding file to initiate a plurality of fund transfers, each of the fund transfers associated with one of the plurality of destination issuers.

15. The server computer of claim 14, wherein the funding file further comprises:
foreign exchange rates for each of a plurality of currencies,
a plurality of values in an originating currency, each value of the plurality of values being associated with each of the destination device files, and
account information associated with the originating issuer and the plurality of destination issuers.

16. The server computer of claim 9, further comprising:
after transferring the plurality of funds to the plurality of destination issuers, receiving a plurality of invoices from the plurality of destination issuers associated with issuing the prepaid funds;
generating, by the server computer, an invoice funding file including exchange information for each of the plurality of destination device files; and
transferring a plurality of invoice funds to the plurality of destination issuers from the originating issuer using the invoice funding file.

17. A system for processing multinational prepaid funding transactions, the system comprising:
an originating issuer computer located in an originating country, the originating issuer computer configured to submit a device file comprising information for a plurality of fund recipients to an exchange server computer;
the exchange server computer configured to:
receive the device file from the originating issuer computer,
split the device file into a plurality of destination device files, each of the destination device files including information for one or more of the plurality of fund recipients,
provide the plurality of destination device files to a plurality of destination issuer computers associated with a plurality of destination issuers; and
transfer a plurality of funds to the plurality of destination issuers from the originating issuer; and
the plurality of destination issuer computers configured to provide a portion of the transferred funds to each of the plurality of fund recipients associated with the received destination device file as prepaid funds.

18. The system of claim 17, wherein the plurality of destination device files correspond to a plurality of currencies.

19. The system computer of claim 17, wherein the plurality of destination device files correspond to a plurality of countries.

20. The system of claim 17, the exchange server computer further configured to:
receive a plurality of invoices from the plurality of destination issuer computers associated with issuing the prepaid funds; and
transfer a plurality of invoice funds to the plurality of destination issuers from the originating issuer.
